(19) United States
(12) Patent Application Publication
(10) Pub. No.: US 2024/0143919 A1
(43) Pub. Date: May 2, 2024

(54) SYSTEMS AND METHODS FOR EXTRACTING DATA FROM DOCUMENTS

(71) Applicant: CIBOLO AI, LLC, Austin, TX (US)

(72) Inventors: Joshua D. ALEXANDER, Austin, TX (US); Brian J. Philpott, Austin, TX (US)

(21) Appl. No.: 18/499,110

(22) Filed: Oct. 31, 2023

Related U.S. Application Data
(60) Provisional application No. 63/421,156, filed on Oct. 31, 2022.

(51) Int. Cl. G06F 40/205; G06F 40/186; G06V 30/12; G06V 30/414

(52) U.S. Cl. CPC G06F 40/205; G06F 40/186; G06V 30/12; G06V 30/414

(57) ABSTRACT

A method of recognizing and extracting data from a document comprises the following steps and may be implemented into a data extraction tool. A document is received from a source. A best-fit template which corresponds to the source is selected, either manually or automatically, from a library of source templates. The document is then parsed into at least one data region based on the selected best-fit template. Raw data from at least one of the data regions is converted to formatted data. The formatted data is then compiled into a formatted data set and may be exported to various destinations.

### RELATED APPLICATION

This application claims the priority benefit of U.S. Provisional Patent Application No. 63/421,156, filed on Oct. 31, 2022. This application is incorporated by reference as it set forth fully herein.

### BACKGROUND OF THE DISCLOSURE

### Field of the Disclosure

The disclosure relates to systems and methods of recognizing and processing documents and software tools implementing the same. More specifically, the disclosure relates to software applications and services for performing operations on documents containing visual and textual data, especially financial documents.

### BRIEF DESCRIPTION OF THE DRAWINGS

FIG. 1 is a flowchart showing steps for performing a method of recognizing and extracting data from a document according to an embodiment of the present disclosure.

FIG. 2 is a flowchart showing steps for performing a method of recognizing and automatically extracting data from a document according to an embodiment of the present disclosure.

FIG. 3 is a flowchart showing steps for performing a method of recognizing and automatically extracting data from a document according to an embodiment of the present disclosure.

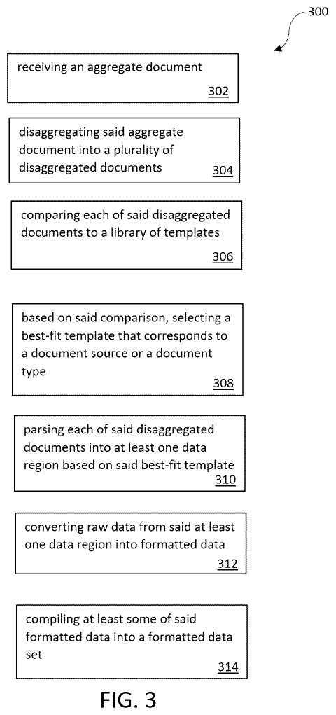

### DETAILED DESCRIPTION OF THE DISCLOSURE

Embodiments of the disclosure can be implemented in numerous ways, including as a method, a process, an apparatus, a system, a composition of matter, a computer readable medium such as a computer readable storage medium or a computer network wherein program instructions are sent over optical or communication links. A component such as a processor or a memory described as being configured to perform a task includes both general components that are temporarily configured to perform the task at a given time and/or specific components that are manufactured to perform the task. In general, the order of the steps of disclosed methods or processes may be altered within the scope of the disclosure.

A detailed description of one or more embodiments of the disclosure is provided below along with one or more accompanying figures that illustrate the principles of operation. Embodiments of the disclosure are described with particularity, but the disclosure is not limited to any embodiment. The scope of the disclosure is limited only by the claims and the disclosure encompasses numerous alternatives, modifications, and equivalents. Specific details are set forth in the following description in order to provide a thorough understanding of the disclosure. These details are provided for the purpose of example, and the disclosure may be practiced according to the claims without some or all of these specific details. For the purpose of clarity, technical material that is known in the technical fields related to the disclosure has not been described in detail so that the disclosure is not unnecessarily complicated.

Various aspects will now be described in connection with exemplary embodiments, including certain aspects described in terms of sequences of actions that can be performed by elements of a computer system. For example, it will be recognized that in each of the embodiments, the various actions can be performed by specialized circuits, circuitry (e.g., discrete and/or integrated logic gates interconnected to perform a specialized function), program instructions executed by one or more processors, or by any combination thereof. Thus, the various aspects can be embodied in many different forms, and all such forms are contemplated to be within the scope of what is described. The instructions of a computer program for recognizing and processing a document can be embodied in any computer-readable medium for use by or in connection with an instruction execution system, apparatus, or device, such as a computer-based system, processor containing system, or other system that can fetch the instructions from a computer-readable medium, apparatus, or device and execute the instructions.

As used herein, a “computer-readable medium” can be any means that can contain, store, communicate, propagate, or transport a program for use by or in connection with an instruction execution system, apparatus, or device. The computer-readable medium can be, for example but is not limited to, an electronic, magnetic, optical, electromagnetic, infrared, or semiconductor system, apparatus, device, or propagation medium. More specific examples of the computer readable-medium can include the following: an electrical connection having one or more wires, a portable computer diskette or compact disc read only memory (CD-ROM), a random access memory (RAM), a read only memory (ROM), an erasable programmable read only memory (EPROM or Flash memory), and an optical fiber. Other types of computer-readable media are also contemplated.

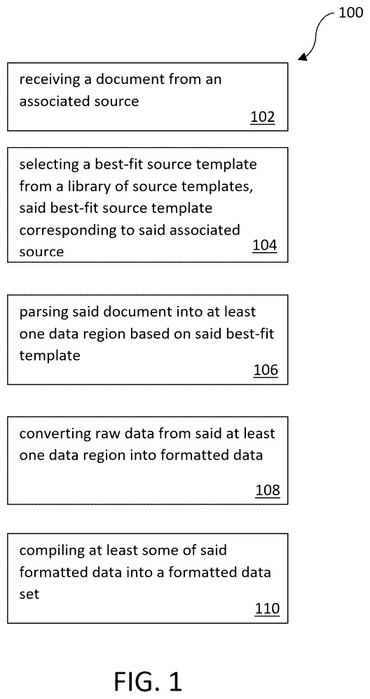

FIG. 1 is a flowchart showing a method 100 of extracting data from a document, either in physical or electronic format, according to an embodiment of the present disclosure. The methods disclosed herein may be implemented as data extraction tools and referred to as such throughout this specification. In certain embodiments, the method may be embodied in a computer-readable medium, or it may be provided using the “software as a service” (SaaS) model, sometimes referred to as “on-demand software” or Web-based/Web-hosted software. In one embodiment, a method of recognizing and extracting data from a document comprises the following steps. A document is received from an associated source (step 102). A best-fit source template which corresponds to the source is selected from a library of source templates (step 104). The document is then parsed into at least one data region based on the best-fit source template (step 106). Raw data from at least one of the data regions is converted to formatted data (step 108). The formatted data is then compiled into a formatted data set (step 110).

In another embodiment, a method of recognizing and automatically extracting data from a document comprises the following steps. A document is received from an associated source (step 202). The document is compared to a library of source templates (step 204). Based on the comparison, a best-fit source template which corresponds to the source is selected from a library of source templates (step 206). The document is then parsed into at least one data region based on the best-fit source template (step 208). Raw data from at least one of the data regions is converted to formatted data (step 210). The formatted data is then compiled into a formatted data set (step 212).

In yet another embodiment, a method of recognizing and automatically extracting data from a document comprises the following steps. An aggregated document is received from an associated source (step 302). The aggregated document is disaggregated into a plurality of disaggregated documents (step 304). Each of the disaggregated documents is compared to a library of templates (step 306). Based on the comparison, a best-fit source template which corresponds to a document source or a document type is selected from a library of templates (step 308). Each disaggregated document is then parsed into at least one data region based on the best-fit source template (step 310). Raw data from at least one of the data regions is converted to formatted data (step 312). The formatted data is then compiled into a formatted data set (step 314).

Although embodiments of the present disclosure may be useful in any industry, certain embodiments are particularly well-suited for use in the financial industry as a tool for receiving and processing financial reporting documents. For example, a Registered Investment Adviser (RIA) receives a number of financial reporting documents associated with various Alternative Investment Groups (AIGs) for each of the RIA's clients. Documents originating from the various AIGs are formatted and organized differently. However, documents from a particular one of the AIGs typically conform to a known template that the AIG has designed such that documents having a particular format and organization can be recognized and associated with the originating AIG. Once a document has been associated with a particular AIG, data can be efficiently extracted from the document and exported according to the instructions of the receiving party, here the RIA. In one embodiment, methods of the disclosure are provided as a software as a service (SaaS) application that is accessed via a website where an RIA signs on to use the data extraction tool.

The above-referenced financial industry application of the systems/methods is exemplary. Indeed, throughout the specification reference is made to the recognition and processing of financial reporting documents; however, it is understood that this is merely one application of the systems and methods disclosed herein. The exemplary application is not intended to limit the disclosure in any way.

Receiving a Document

A user of the disclosed systems/methods, in this case an RIA, will receive documents from various companies containing client financial data. The documents may be received via paper mail, in which case the document will be a physical copy, or they may be received digitally by email, for example. Physical documents can be digitized using a scanner or the like. The digital documents can be stored on a server for processing immediately or at a later time.

An RIA may receive a single document or it may receive several documents which require processing. That is, an RIA may receive a single document from an AIG that corresponds to a single client, or an RIA may receive a single aggregate document that corresponds to several clients or several document types, in which case it may be necessary to disaggregate the document into its component parts. Such documents are frequently delivered electronically in the pervasive Portable Document Format (PDF) file type.

Selecting a Template

When the user is ready, one or more files are selected for processing as the documents may be processed individually or in batches. The documents to be processed may be selected using drag-and-drop techniques, for example, to facilitate initiation. Once the desired files are chosen, in this particular embodiment, the user selects at least one best-fit template which corresponds to the source of the document or batch. If all the documents to be processed are from a single source, then a single template may be selected. If there are multiple document types in the batch, or if the documents within a batch originate from multiple sources, then multiple corresponding templates may be selected. For example, a user may recognize a document as originating from a particular AIG by noting the name of the AIG somewhere on the document where the name would be expected to appear. The user may use any means necessary to identify the document source. If multiple templates are selected, then the templates are compared against the documents such that the appropriate template is used for each document.

Parsing the Document

Then, based on the selected best-fit template, the document is parsed into at least one data region. A given source will generally format its documents uniformly such that there is an expectation that data of a certain type will be found in a particular place in the document. For example, a given source may always place its name and/or logo in the upper right-hand corner of the document. Likewise, that same source may include important numerical data that relates to fund performance on the lower-left hand corner of the first page of the document. Thus, it is possible to build a template which reflects the likely location of important data in a document that originates from a given source. The data may be visual data (e.g., logos or pictures), textual data (e.g., words, symbols, and numbers), or any combination of both. Each template is created based on the analysis of documents from a given source to indicate the likelihood that data of a certain type will be found in an associated data region. An incoming document is then parsed into data regions according to the selected best-fit template.

Converting Raw Data to Formatted Data

Once the data regions have been mapped onto the document based on the associated best-fit template, the data in at least some of those regions may be converted into a desired data format. For example, based on the template, the source name may be expected to be in a certain data region of the document (i.e., the “source name” data region), so the image or other data type found in that data region may be converted into a text string using optical character recognition (OCR) techniques, for example. In another area of the document, the template may indicate that a fund balance is expected to be displayed in the “fund balance” data region. The image or other data type of that fund balance may then be converted to a numerical value having a specific format. In yet another area of the document, an image of the source logo may be found in the “source logo” data region. The image or other data type of that logo may be converted to a picture file, such as a jpeg or a bitmap. In this way, the best-fit template allows the conversion of raw data, typically images but possibly other data types, in certain regions of the document to be converted to data having a useful format which can then be aggregated into a formatted data set and conveniently exported.

Compiling the Formatted Data

After the raw data from the various data regions has been converted to formatted data, a formatted data set may be compiled. The data set may be organized into a comma separated value (CSV) format or any other desired format. For example, raw data may be extracted from the “client name” data region of the document according to the best-fit template and converted into a text string. The newly formatted text string can then be parsed and compiled into a table or spreadsheet under the fields “client first name” and “client last name” to give the data additional context and utility. At this point the user may want to make certain changes to the formatted data set, for example, to correct a typographical error or to add contextual information (e.g., a “comments” field); thus, the compiled formatted data set may be editable to allow for such corrections, revisions, and additions.

Exporting the Formatted Data Set

Once the data is compiled into a formatted data set, it may be easily exported to various destinations. The formatted data set can be easily tailored to conform to preset third-party specifications. For example, RIAs typically use a portfolio management software (PMS) to track and report client portfolios. Now that the RIA has compiled the formatted data set, it is possible to push the set directly to the PMS. Thus, the RIA can design a formatted data set template that allows for formatted data sets to directly flow into the PMS. Once a user is authenticated into the service that provides the data extraction tool, the formatted data set can be pushed via an application programming interface (API) to the PMS. This can be done seamlessly and conveniently without requiring the user to separately log on and authenticate to the PMS. Formatted data sets can be easily tailored for export to many different intended destinations.

Automated Template Selection and Creation

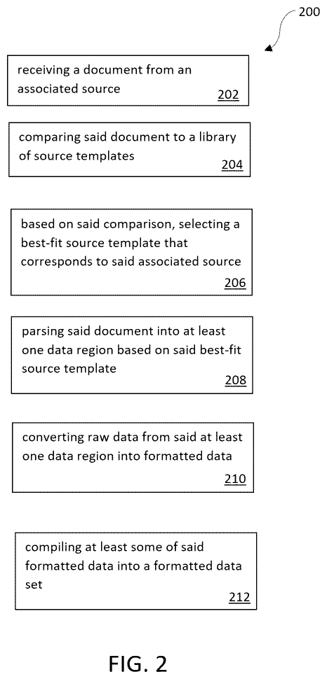

FIG. 2 is a flowchart showing a method 200 of recognizing and automatically extracting data from (or otherwise processing) a document, either in physical or electronic format, according to another embodiment of the present disclosure. The method shown in this figure is similar to that shown in FIG. 1, discussed supra. In this particular embodiment, the template is automatically selected by comparing the incoming document with a library of source templates. The template may be selected using various best-fit algorithms which may be informed and improved with machine learning techniques or the like. Once the template is selected, the method shown in FIG. 2 operates similarly as that shown in FIG. 1 by parsing the document into data regions, converting raw data to formatted data, and then compiling it into a formatted data set.

The template library itself may be manually created by adding templates for each new desired document source format, or it may be dynamically created by with a template creation tool. Such a tool would analyze a new source document, compare it with existing templates in the library, and determine whether a new template is necessary. If a new template is necessary, the creation tool can recognize the existence of various common data types in a new source document and define the various data regions for the new template. Because several templates will already be available in the library, a supervised learning technique may be appropriate to train the template creation tool.

Additional Automation

Various additional automated features may be added to improve functionality of the data extraction tool. In one embodiment, the data extraction tool can learn patterns of data intake for a particular RIA. For example, if the tool processes documents from a certain source at a regular interval (e.g., monthly or quarterly), the tool can generate automatic alerts to remind the RIA that a particular document or class of documents has not been received and processed, prompting the staff to locate the documents and/or initiate processing.

Embodiments of the data extraction tool can be set up to receive and process new incoming documents directly via email or another electronic delivery mechanism. For example, AIGs routinely report statements to RIAs via email with documents included as attachments, often PDFs. The tool can be set up to automatically download the attachments from the incoming emails, store them in a specified location, and process them at a set time. Reporting emails from the various AIGs can be detected by scanning all incoming emails, or AIGs can be instructed to send the reporting emails to a specified RIA email address which is specifically monitored for this purpose. Other methods of detecting incoming source documents for automatic processing may also be used.

Indeed, it possible to automate the entire process from document intake to integration with PMS.

As previously noted, this specification relates to the data extraction methods applied to reporting documents in the financial industry; however, a person of skill will recognize that similar methods and tools can be applied to other industries where data extraction and reporting is required, such as, e.g., the energy and medical industries.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular disclosures. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Furthermore, unless dictated by operability, the flow charts depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

We claim:

1. A method recognizing and extracting data from documents, comprising:
receiving a document from an associated source;
selecting a best-fit source template from a library of source templates, said best-fit source template corresponding to said associated source;
parsing said document into at least one data region based on said best-fit source template;
converting raw data from said at least one data region into formatted data; and
compiling at least some of said formatted data into a formatted data set.

2. The method of claim 1, further comprising:
arranging said formatted data set into a formatted report; and
outputting said formatted report to a user.

3. The method of claim 1, wherein said formatted data set is tailored to conform to a preset third-party specification.

4. The method of claim 1, wherein said document is a financial reporting document.

5. The method of claim 1, wherein said document is a physical document.

6. The method of claim 1, wherein said document is a digital document.

7. The method of claim 1, wherein said raw data comprises visual data, textual data, or a combination of visual data and textual data.

8. The method of claim 1, wherein said parsing step further comprises mapping said data regions onto said document based on the location of corresponding data regions in said best-fit source template.

9. The method of claim 1, wherein said at least some of said raw data is converted into formatted data using an optical character recognition algorithm.

10. The method of claim 1, further comprising:
reviewing said formatted data set for errors and/or accuracy.

11. A method of recognizing and automatically extracting data from documents, comprising:
receiving a document from an associated source;
comparing said document to a library of source templates;
based on said comparison, selecting a best-fit source template that corresponds to said associated source;
parsing said document into at least one data region based on said best-fit source template;
converting raw data from said at least one data region into formatted data; and
compiling at least some of said formatted data into a formatted data set.

12. The method of claim 12, further comprising:
after comparing said document to said library of source templates, determining if a suitable best-fit template exists;
if no suitable best-fit template exists, creating a new template; and
adding said new template to said library of source templates.

13. The method of claim 11, further comprising:
wherein documents from a particular source arrive periodically, generating an alert indicating that documents from said particular source have not been received within an expected period.

14. The method of claim 11, wherein said step of receiving said document further comprises:
searching a plurality of electronic messages;
designating at least some of said messages and/or attachments to said messages as documents for processing at a specified time; and
downloading said documents for processing to a storage location.

15. A method of recognizing and automatically extracting data from documents, comprising:
receiving an aggregate document;
disaggregating said aggregate document into a plurality of disaggregated documents;
comparing each of said disaggregated documents to a library of templates;
based on said comparison, selecting a best-fit template that corresponds to a document source or a document type;
parsing each of said disaggregated documents into at least one data region based on said best-fit template;
converting raw data from said at least one data region into formatted data; and
compiling at least some of said formatted data into a formatted data set.

16. The method of claim 15, further comprising:
arranging said formatted data set into a formatted report; and
outputting said formatted report to a user.

17. The method of claim 15, wherein said formatted data set is tailored to conform to a preset third-party specification.

18. The method of claim 15, wherein said raw data comprises visual data, textual data, or a combination of visual data and textual data.

19. The method of claim 15, wherein said parsing step further comprises, for each of said disaggregated documents, mapping said data regions onto said disaggregated document based on the location of corresponding data regions in said best-fit source template.

20. The method of claim 15, further comprising:
reviewing said formatted data set for errors and/or accuracy.
